(19) United States
(12) Patent Application Publication
(10) Pub. No.: US 2010/0138566 A1
(43) Pub. Date: Jun. 3, 2010

(54) Control System for Legacy Computers Using Peripheral Devices

(75) Inventor: Henry A. Knight, Centerville, OH (US)

Correspondence Address: THOMPSON HINE L.L.P.;Intellectual Property Group, P.O. BOX 8801, DAYTON, OH, 45401-8801, US

(73) Assignee: RITE TRACK EQUIPMENT SERVICES, INC., West Chester, OH (US)

(21) Appl. No.: 12/575,967

(22) Filed: Oct. 8, 2009

Related U.S. Application Data
(60) Provisional application No. 61/146,040, filed on Jan. 21, 2009.
(60) Provisional application No. 61/118,635, filed on Nov. 30, 2008.

(51) Int. Cl. G06F 3/00

(52) U.S. Cl. 710/18

(57) ABSTRACT

A system and method for transferring data with a peripheral of a computer controlled system is presented. The system and method comprises a means for monitoring an interface cable between the peripheral and the peripheral controller to identify an idle interval, a switching means for connecting a controller to the interface cable for transferring data between the controller and the peripheral, and a communications port for transferring commands and data between the controller and an another computer. The system and method transfers data with the peripheral without consuming memory or CPU resources of the computer controlled system.

### CROSS REFERENCE TO RELATED APPLICATIONS

This application claims the benefit of U.S. Provisional Application No. 61/118,635, filed Nov. 30, 2008, entitled “Method for Interfacing with Hard Drives”, and U.S. Provisional Application No. 61/146,040, filed Jan. 21, 2009, entitled “Communications and Control System for Processing Equipment and Other Devices”, each of which is herein incorporated by reference in its entirety.

### FIELD

Embodiments of the subject matter described herein relate generally to a system and method for coupling to an interface cable between a hard drive and a hard drive controller in order to add functional capabilities to an existing legacy computer system.

### BACKGROUND

Computers typically use peripheral devices for storage of data and programs. The most common type of peripheral device is a hard drive. A hard drive has one or more spinning disks, or coated metallic platens, onto which data is written in the form tiny magnetic domains representing 1s and 0s. Data is transferred from the peripheral to the motherboard using a standardized interface such as IDE, EIDE, SCSI, ATA, PATA, SATA, and FDDI.

A hard drive controller is used to control the process of reading and writing to the hard drive. The hard drive controller is often integrated into the motherboard, or is in the form of a hard drive controller board that is plugged into one of the motherboard's expansion I/O slots, for example an ISA slot. The hard drive controller communicates with the hard drive over an interface cable using the interface protocol for the specific standardized interface of the hard drive and hard drive controller. Computers transfer data and programs from peripheral devices across the interface cable.

To access data or programs from the hard drive, a user generally issues commands through the operating system or an application on the computer system. For example a user can type in a DOS command or click a mouse button if running Windows or another graphical user interface based system. But if the system is running proprietary software, for example a protected memory operating system or one that uses a real time kernel, the user may be restricted from accessing the data on the hard drive. In some situations, the source code for modifying an application may be unavailable, making it difficult to adjust the operation of the legacy computer system.

Also, if a user has a need or desire to access the data on the system remotely through a network, the computer system must have a network interface and software that supports networking. For some systems, it may be impossible or impractical to add network cards, for example if there is no open I/O expansion slot available. In some older or proprietary systems, the operating system may not be capable of supporting network interfaces, or there may not be a compatible network interface adapter available that is compatible with the hardware of the legacy computer system.

### SUMMARY

Presented is a control system for directly accessing the hard drives of legacy computer systems. In embodiments, the control system comprises a controller and interface cable that attaches to the hard drive through the existing interface cable between the hard drive controller and the hard drive on the legacy computer system. The controller allows access to the contents of the hard drive, allowing the controller to read and/or write to the hard drive of the legacy computer system. In an embodiment, the controller writes data to the hard drive of the legacy computer system that alters the operation of the legacy computer system. In an embodiment, the controller has network functionality allowing a remote user or computer system to access the data on the hard drive of the legacy computer system. In an embodiment, the controller is a computer system. In an embodiment, the controller is a card that plugs into an expansion I/O slot of the legacy computer system.

The features, functions, and advantages discussed can be achieved independently in various embodiments of the present disclosure or may be combined in yet other embodiments further details of which can be seen with reference to the following description and drawings.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawings in which the reference number first appears.

FIG. 1 is an illustration of a legacy computer system having a controller attached to the interface cable via a coupler, in one embodiment of the control system for legacy computers using peripheral devices.

FIG. 2A is an illustration of a legacy computer system with a controller adapted to use the legacy computer system's ISA bus for power and using a serial port for output, in one embodiment of the control system for legacy computers using peripheral devices.

FIG. 3 is an system diagram of a plurality of networked computer controlled track machines of a semiconductor wafer processing facility, in one embodiment of the control system for legacy computers using peripheral devices.

FIG. 4 is an exemplary control screen for selecting a track machine in the semiconductor wafer processing facility for control, in one embodiment of the control system for legacy computers using peripheral devices.

FIG. 5 is an exemplary control screen for selecting an operation to perform on a track machine in the semiconductor wafer processing facility for control, in one embodiment of the control system for legacy computers using peripheral devices.

### DETAILED DESCRIPTION

The control system for legacy computers permits direct accessing of the data of a peripheral device of a legacy computer system. In an embodiments, the peripheral device is a hard drive containing data and programs of the legacy computer system.

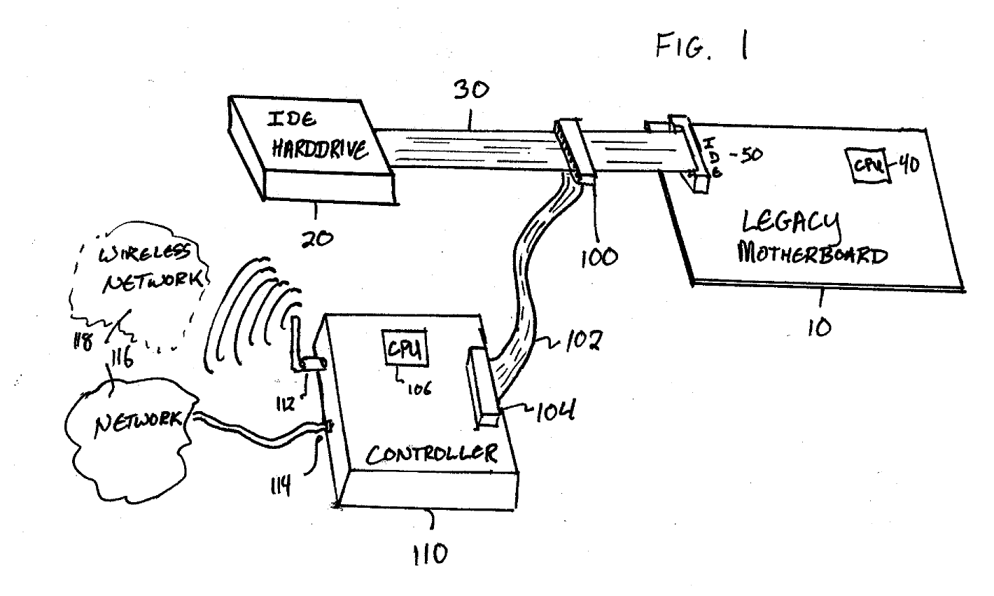

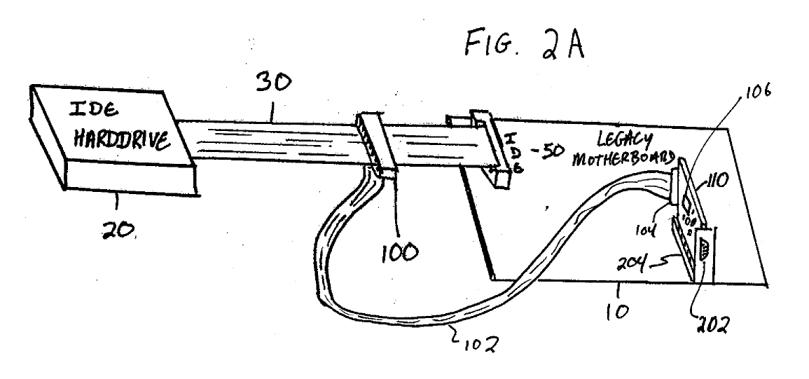

FIG. 1 depicts a legacy computer system having a legacy motherboard 10, a CPU 40, an integrated IDE hard disk controller 50, an IDE hard drive 20, and an interface cable 30. The hard disk controller 50 communicates with the IDE hard drive 20 via an interface cable 30. The control system comprises a coupler 100, a second interface cable 102, and the controller 110 that further comprises a CPU 106, a wireless interface 112 and an ethernet interface 114. The wireless interface 112 and an ethernet interface 114 allows the controller 110 to communicate through a wireless network 116 or a network 118. In alternate embodiments the communications interface is a network interface, a serial interface, a fiberoptic interface, a wireless network interface, an 802.11 interface, a WIFI interface, an RS-232 interface, a USB interface, a 1394 interface, an Ethernet interface, and/or a 10/100/1000 base T interface.

The coupler 100 is a means of connecting to the interface cable 30, and the second interface cable 102 is a means of routing the electrical signals of the interface cable 30 to an IDE cable connection port 104 on the controller 110. The interface cables 30 are dependent on the particular standardized interface such as IDE, EIDE, SCSI, ATA, PATA, SATA, and FDDI. In various embodiments, the interface cables 30 are ribbon cables, serial cables, multi-strand cables, optical cables, or twisted pair cables appropriate for the particular standardized interface.

To access the data of the hard drive 20, the coupler 100 is clamped to the interface cable 30. The clamping action causes the coupler 100 to pierce or displace the insulation on the wires of the interface cable 30 and make electrical contact with the individual wires of the interface cable 30. The coupler 100 electrically connects the wires of the interface cable 30 to the controller 110 through the second interface cable 102 and IDE cable connection port 104. The controller 110 accesses the contents of the hard drive 20 and in embodiments described later, either reads and/or writes to the hard drive 20 of the legacy computer system. In embodiments, the controller 110 is a custom built device, a computer system such as a laptop or desktop PC, a netbook, a PDA, or any other computing device as would be obvious to one of ordinary skill in the art.

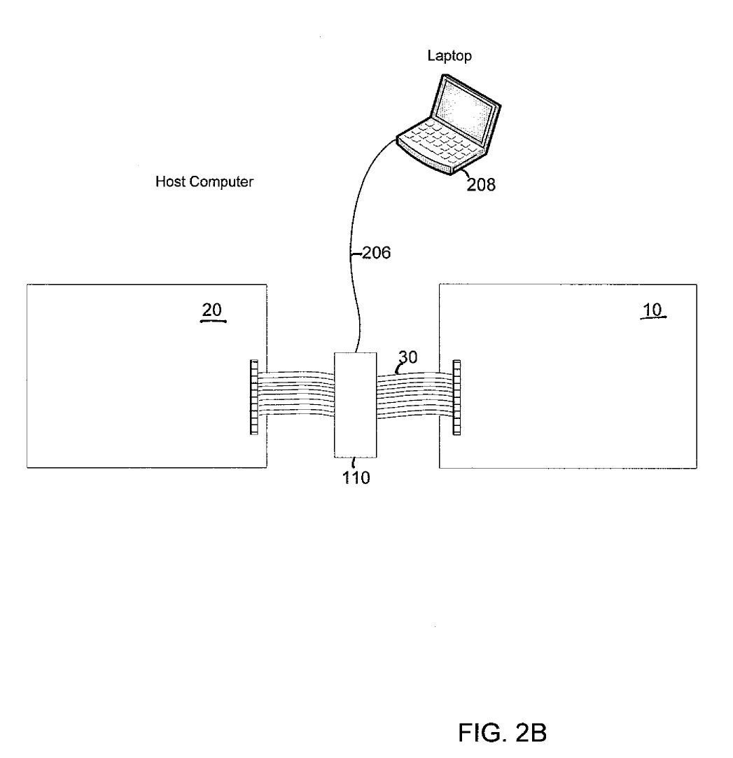

Referring now to FIG. 2, in an embodiment the controller 110 is a card that plugs into an expansion I/O slot 204 of the legacy computer system. FIG. 2A depicts a legacy computer system having a legacy motherboard 10, a CPU 40, an integrated IDE hard disk controller 50, an IDE hard drive 20, an interface cable 30, and an expansion I/O slot 204. The hard disk controller 50 communicates with the IDE hard drive 20 via an interface cable 30. The control system comprises a coupler 100, a second interface cable 102, and the controller 110 that further comprises a CPU 106, and a serial interface port 202. The controller 110 plugs into the ISA expansion I/O slot 204 of the motherboard 10 of the legacy computer system. In one embodiment, the controller 110 only draws power from the expansion I/O slot 204. The serial interface port 202 allows the controller 110 to communicate with another computer or connect to a network via a terminal server or PAD (packet assembler/disassembler.)

This configuration of the embodiment of FIG. 2A presents several additional advantages. A first advantage is that placing the controller close to the interface cable reduces the length of the second interface cable 102, which in turn reduces the loading and coupling effects that can corrupt data transfers, especially at higher transfer speeds. A second advantage is that this configuration allows the second interface cable 102 to remain inside of the chassis of the legacy computer system, both reducing space requirements and reducing the likelihood of damage to either the second interface cable 102 or the interface cable 30 to which it is attached. A third advantage is that the controller 110 is powered from the legacy computer systems I/O expansion bus, and therefore does not require an external power source or power socket, ensuring that the controller 110 is on when the legacy computer system is on. In an embodiment, the controller 110 has a coupler 100 in place of the IDE interface port 104, allowing the interface cable 30 to be positioned near the controller 110 and directly clamped to the controller 110, thereby eliminating the need for a second interface cable 102.

Referring now to FIG. 2b, in an embodiment, the controller 110 attaches directly to the interface cable 30, for example between the hard drive 20 and the motherboard 10, and connects via a USB serial communications link 206 to a laptop 208. This embodiment also eliminates the need for a second interface cable 102. The USB serial communications link 206 provides power to the controller 110 from the laptop 208. Some interface cables 30 provide power and ground. In an embodiment, the controller 110 is a low power device and derives power from the interface cable 30. In embodiments, the USB serial communications link 206 is a serial, optical, network link, and or a link providing power. In embodiments, the laptop 208 is any suitable computing device as would be understood by one of ordinary skill in the art.

In embodiments, the controller 110 monitors data being read or written to the hard drive, reads data from the hard drive 20, and writes data to the hard drive 20. In an embodiment, the controller 110 allows a remote networked user or connected computer to access data from the hard drive. In an embodiment, the controller 110 converts all data from the hard drive 20 into a format compatible with the remote system. In one embodiment, the controller 110 allows the hard drive 20 to be mapped as a network drive. In an embodiment, the controller 110 writes data to the hard drive 20 of the legacy computer system that alters the operation of the legacy computer system, thereby allow a remote networked user or computer to control the operation of the legacy computer system.

### Modes of Operation

To read or write to a portion of the hard drive 20, the controller 110 has to avoid reading or writing at the same time as the legacy system's hard drive controller 50. If the controller 110 attempts to read or write at the same time as the hard drive controller 50, it can corrupt the data passing between the hard drive controller 50 and hard drive 20 which can create errors on the hard drive 20 or cause an exception fault in the hard drive controller 50. This is sometimes referred to as bus contention. The controller 110 uses different modes of operation to avoid causing cause bus contention.

The controller 110 comprises a set of switching relays, such as tri-state electronic switches, that default into a fail-safe arrangement that does not interfere with the normal bi-directional flow of data between the hard drive controller 50 and the hard drive 20 or the operation of the control lines. When activated, either by a remote user or computer, the controller 110 activates the tri-state electronic switches and depending on the mode of operation, either monitors the data communications between the hard drive controller 50 and the hard drive 20, or issues commands to the hard drive 20 to read from or write to the hard drive 20 by driving the appropriate control lines and placing data and addressing information onto the appropriate bus lines of the interface cable 30. The tri-state electronic switches are one example of switching means that are used to accomplish the objective of preventing the controller 110 from unintentionally corrupting a data transfer between the hard drive controller 50 and the hard drive 20.

### Read-Only Mode

In the read-only mode of operation, the controller 110 monitors the interface cable 30 but does not attempt to write to the hard drive 20. The controller 110 creates a mirror copy of the hard drive 20 by tracking the read and write operations between the hard drive controller 50 and the hard drive 20. The read-only mode allows data on the hard drive 20 to be passed to other network computer systems, but does not allow a remote system to control the system or modify the data on the hard drive 20.

### Bus Arbitration Mode

Certain interfaces, for example SCSI, have built in bus arbitration mechanisms, allowing a second SCSI hard drive controller to read and write to the hard drive 20. In the bus arbitration mode, the controller 110 uses the bus arbitration mechanism to perform a read or write operation to the hard drive 20 using a SCSI controller. In bus arbitration mode, there is generally no problem of bus contention, however in one embodiment the controller 110 will monitor the SCSI bus to ensure that and reading or writing does not occur at the same time that the legacy computer system is attempting to read or write from the hard drive 20 so as to prevent delay or timing errors in the legacy computer system.

### Idle Hard Drive Control Modes

In the idle hard drive control mode, the controller 110 or a remote system that is networked to the controller 110 only performs read or write operations with the hard drive controller 50 during periods when the hard drive controller 50 is not reading or writing to the hard drive 20. There are three general idle hard drive controller submodes.

In a first submode, the known idle submode, the controller 110 is only requested to read or write to the hard drive 20 during known idle periods where it is known that the system will not be accessing data from the hard drive 20. This is effective with certain systems, for example older DOS based systems, where the operating system does not generally read or write to the hard drive 20 unless the system is specifically running an application or a when command has been invoked.

In a second submode, the burst idle submode, the controller 110 monitors the interface cable 30 for an idle period when no reading or writing has occurred for a threshold period of time, and then asserts a read or write operation during anticipated idle periods. In many applications, reading or writing to the hard drive 20 is performed in bursts. For example, when first running an application on older machines using legacy operating systems, the operating system reads the program and associated data from the hard drive 20 and then runs the application. For some applications, the operation system and/or application may not read or write again to the hard drive 20 during the running of the application, or may read or write to the hard drive 20 in a predictable pattern.

In a third submode, the predicted idle submode, the controller 110 learns the read/write patterns for the operation system and hard drive 20 by monitoring the interface cable 30 and heuristically predicts available times slots for performing read/write operations with the hard drive 20 based on past operations of the hard drive controller 50.

### Busy Assertion Control Mode

In the busy assertion hard drive control mode, the controller 110 actively drives one or more of the signal lines to the hard drive controller 50 thereby making the hard drive controller 50 see the hard drive 20 as busy or not ready for the next read or write operation. During this busy assertion interval, the controller 110 performs one or more read or write operations with the hard drive 20. In one embodiment, the controller 110 performs only a single read or write operation to avoid having the hard drive controller 50 time out or otherwise send a fault to the operating system that could interrupt its normal operation.

In one embodiment, the controller 110 monitors the communications between the hard drive 20 and the hard drive controller 50. When the hard drive controller 50 attempts to read the status register of the hard drive 20, the controller 110 overwrites a portion of the data send by the hard drive 20, thereby making the hard drive 20 appear to have the BUSY flag set in the status results. The operating system will generally wait a short time interval before requesting the status again from the hard drive 20. The controller 110 then performs a read/write operation in that time interval.

In another embodiment, the controller 110 drives the -IOCHRDY line, or 10 channel ready line, to make the hard drive 20 appear not be ready to accept additional data transfer requests. The controller 110 then tri-states the -IOCHRDY allowing normal operation between the hard drive 20 and the hard drive controller 50.

### Tri-State Hard Drive Control Mode

In the tri-state hard drive control mode, one or more of the signal lines between the hard drive controller 50 and the hard drive 20 are cut. In one embodiment, only some of the control lines are cut and connected to one or more tri-state circuits, allowing the controller 110 to selectively assert different signals to the hard drive controller 50 and the hard drive 20 or selectively pass signals between the hard drive controller 50 and the hard drive 20. In this mode the default setting for the tri-state control is to allow data to pass between the hard drive controller 50 and the hard drive 20, allowing the legacy computer system to operate normally until the controller 110 is activated.

### Buffered Hard Drive Control Mode

In the buffered hard drive control mode, the interface cable 30 between the hard drive controller 50 and the hard drive 20 is disconnected and a first cable is placed between the hard drive controller 50 and the controller 110, and a second cable is placed between the controller 110 and the hard drive 20. In this embodiment, the controller 110 has complete control over access to the hard drive 20 from the hard drive controller 50. The controller 110 buffers commands and data between the hard drive controller 50 and hard drive 20, or creates a virtual copy of the hard drive 20, allowing the hard drive controller 50 and a remote computer to have simultaneous access to the virtual hard drive 20. In this mode tri-state switches default to allowing data to pass between the hard drive controller 50 and the hard drive 20, allowing the legacy computer system to operate normally until the controller 110 is activated.

### Applications

The control system is applicable to both legacy computer systems and new computer systems. For example, even if a system has an I/O expansion slot available and system drivers that can support a network interface card, there are times when adding such a card would interact negatively with the function of the system. For example, in some real-time data acquisition systems, the software is written where the code is “hung” in a tight loop waiting for events to occur, for example when monitoring various input points, solving logic, and writing outputs during a test. Placement of a network card into such a system could adversely affect the outcome of the test by allowing any network generated interrupts to utilize system resources thereby potentially skewing sensitive timing data and altering the test results.

Because the control system resides outside the operating system of the target computer system, it does not utilize any system resources, such as memory resources, or consume any CPU cycles of the target machine. Some older legacy computer system have limited available memory, especially older DOS base system that were limited to 640 k of base memory. Adding network cards and network drivers consumes valuable system resources that could affect performance of the legacy computer system and prevent applications with higher memory requirements from being able to run.

The control system is particularly applicable to Real Time Operating Systems (RTOS.) In non-RTOS systems, applications such as network drivers can often be loaded using Terminate and Stay Resident (TSR) type programs. Many RTOS systems do not support networks have protected mode environments that make access to the hardware of the target system difficult or impossible to achieve. Because the control system operates outside of the internal operating system of the target machine, the control system functions largely independently of the operating system. Further, no additional code needs to be written for the legacy computer system, meaning that the control system is especially applicable to those older legacy computer system where the code has been lost or when it is difficult to find either the development system necessary to make code changes or programmers familiar with the original design of the software on the legacy computer system.

### Control System for Processing Equipment

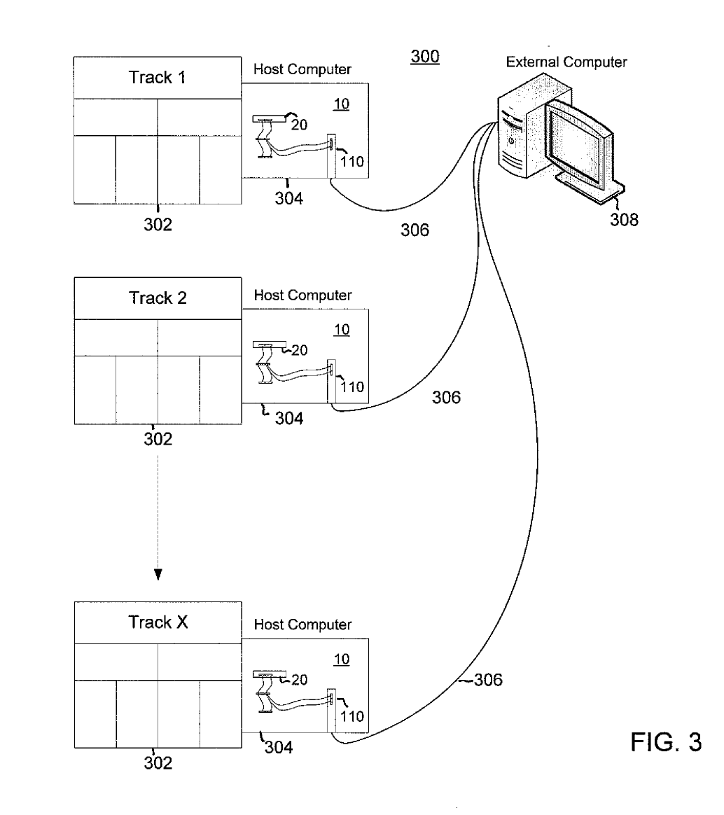

Referring now to FIG. 3, an exemplary control system for a semiconductor wafer processing facility 300 including multiple track machines 302 is shown. Each track machine 302 includes an internal host computer 304 having a hard drive 20 and a motherboard 10. The controller 110 is a printed circuit board that connects directly to a I/O expansion slot in the host computer 304. Using serial cables 306, an external computer 308 is linked to each of the track machines 302 via the controllers 110.

With respect to the hardware interface, in embodiments the external computer 308 is a standard Windows XP computer and each host computer 304 is a an older DOS based computer system running a Japanese version of Microsoft DOS 3.3 most commonly referred to as JDOS. The DOS computer is typically a NEC 9801 or 9821 series computer.

Each controller 110 enables additional functionality for controlling the legacy manufacturing equipment, the multiple track machines 302. For example, it is not uncommon for the traditional external/remote communications interface of legacy manufacturing equipment to place limits on the ability to modify machine performance and/or access data. By adding the controller 110, the external computer 308 has direct access to the legacy control code on the hard drive 20, bypassing many control limits that might be incorporated into the traditional external/remote communications interface. For example, use of the controller 110 enables remote control of the track machine 302, via the external computer 308, in the same manner as the local interface of the legacy machine. Many, if not all, functions that used to be performed only via the local interface can now be performed remotely. Moreover, the use of the controller 110 enables remote control of the track machines 302 in a manner to provide functions beyond those enabled by the local interface.

In an embodiment, the external computer 308 and a host computer 304 are connected via a “null modem” serial cable 306, for example using a 38.4 kb/s serial link, for transferring commands and data files. A Windows XP machine is the external computer 308 acts as the “client” system and an NEC machine is the host computer 304 and acts as the “server”. In this embodiment, all commands sent to the controllers 110 originate on the Windows XP (client) machine 308. The software is designed where the client 304 can request or send files one at a time, or by using wild cards, such as “*” or “?” (similar to DOS based commands). The exact switch syntax can vary, but the objective is to provide a means to transfer many files without having to send multiple commands. The controllers 110 translate the commands into read and write requests for the hard drives 20.

In an embodiment, the software utilizes a form of data compression. Many files are text based, are in excess of 1 megabyte, and are easily compressed. The external computer 308 compresses the files prior to sending them across the serial cable 306, and the controller 110 uncompresses the files as they are sent to the hard drive 20. Similarly, the controller 110 simultaneously compresses the files from the hard drive 20 while transmitting a continuous stream of data to the external computer over the serial cable 306. In addition, appropriate handshaking and error checking are implemented to ensure transmission of the data is completed without errors.

Below are three example communications between the server 304 and client 308. During the initial setup, the operator selects a subdirectory on the client machine 308 where all files will reside during file transfer, i.e.: c:\backup.
1. operator request all *.txt files from root dir of server 304
2. command get *.txt is sent to server 304
3. *.txt files compress and stream simultaneously to client 308
1. Operator selects all *.txt files from entire hard drive 20 on server 304
2. Command get *.txt /s is sent to server 304
3. *.txt /s files are compressed and streamed simultaneously to client 308
4. the files in the c:\backup directory may contain multiple subdirectories at this point
1. operator sends all *.txt files from client 308 to server 304
2. command put *.txt is sent to server 304
3. *.txt files are compressed and stream simultaneously from client 308 to the server 304

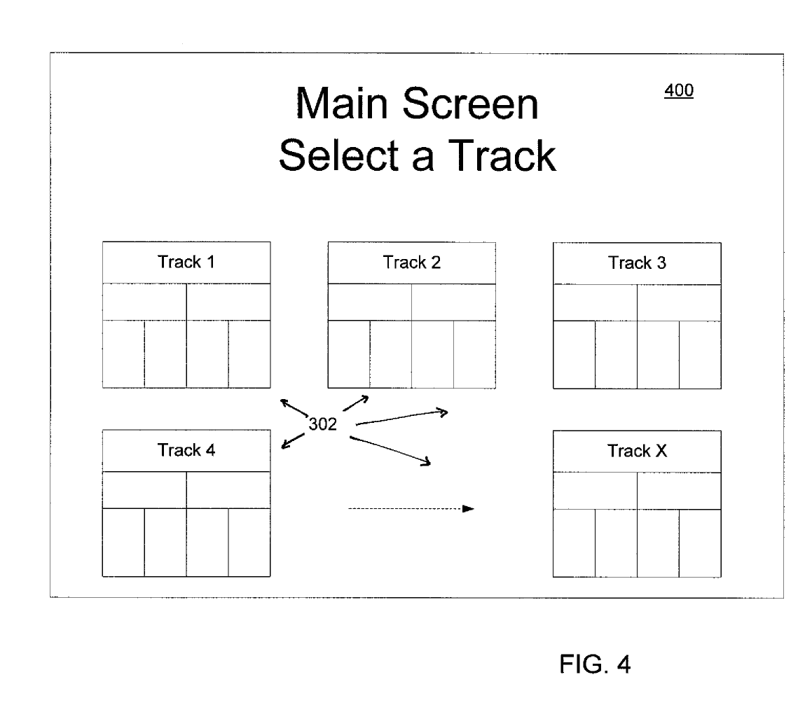

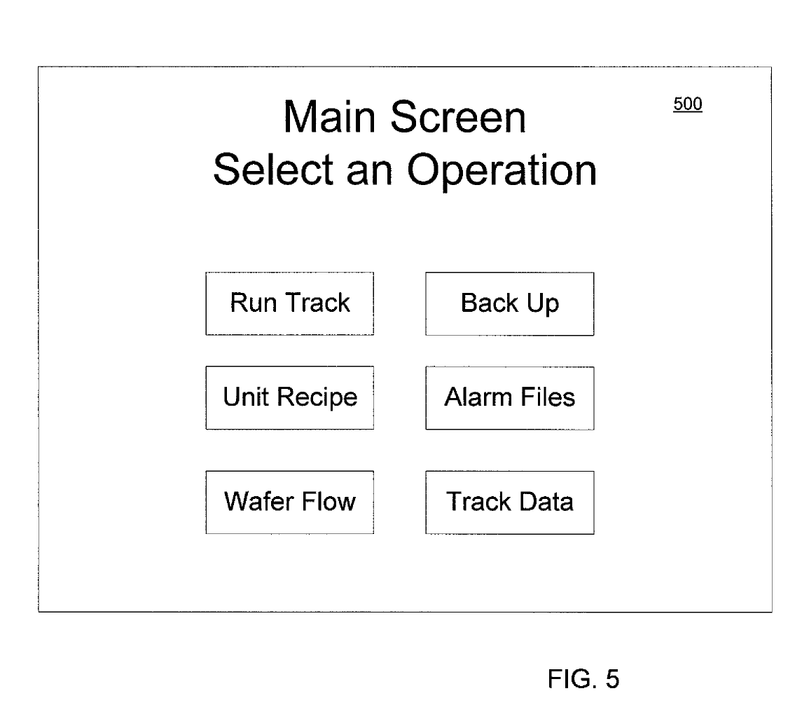

FIG. 4 shows an exemplary interface screen 400 of the external computer 308. The interface screen 400 enables an operator to select a track machine for communication/set-up. FIG. 5 shows an interface screen 500 providing options once a given track machine 302 has been selected.

An exemplary semiconductor wafer processing facility comprises:

ARDiMuS GEM (Mark ⅞ only)
Wafer event driven providing greater time granularity

Automatic Disk Back Up

Teaching Pendent (uses separate mini computer for local calibration)

Additional embodiments
Robo Eye!—automatic mechanical calibration
Resist Bottle control

### New Benefits Provided Include:

All Mark Series Tracks are networked via standard Ethernet
Automatic Back Up (to ARDiMuS Area Computer)

Access to Process Control data
Unit Recipes (including dispense arm and pump recipe parameters)
Wafer Flows

Improves Access to Alarm Log files

Track Status
On line operation

Intelligent Pump programming (T-100 OK; others roadmap)

Control of all available data
Error proofing for track-to-track recipe transfers

Analysis of all data
Engineering Change Control

Alarm Analysis
Email/Pager notification of concerns

### Enhancements Include:

No powering down to run Machine Data Backup, Teaching, Recipe Backup, etc. . . .

Increased Uptime
No stressing electrical or mechanical components during power transitions

Ease of Maintenance

Functionality Increase
Swing Curves
Multi-lot processing (depending on the SW Option in the track)

Operational Error proofing
Barcode management
   Recipe download and run control
   Badge scanning
      Targeted Improvements include:

IT
Tracks are all networked for data storage and transfer

Operations
Error reduction capabilities

Equipment Engineering
Supervisory Access
Real time operational data collection and analysis

Process Engineer
Process data analysis
   Gap Analysis
   Thermal History
   Peripheral control
Engineering Change Control of Unit Recipes & Wafer Flows

Purchasing
Reduced rework/scrap—error reduction
Improved yield—Process data analysis
Increased productivity—decrease downtime
Security of all track related data and programming files—Automatic Backup

### Software

Software developed for the controller 110 is written in Microsoft Visual C+ from Visual Studio 6, for example as a DLL, and is imported into a Visual Basic application and event driven. In another embodiment, the software is developed in Visual Basic. Software written on the NEC computer is developed in DOS C. Sections of the code are written in Assembly to access hardware.

While various embodiments of the present invention have been described above, it should be understood that they have been presented by the way of example only, and not limitation. It will be understood by those skilled in the art that various changes in form and details may be made therein without departing from the spirit and scope of the invention as defined. Thus, the breadth and scope of the present invention should not be limited by any of the above-described exemplary embodiments.

We claim:

1. A system for accessing data of a computer controlled system, comprising:
a means for monitoring an interface cable between a peripheral and a peripheral controller of the computer controlled system to identify an idle interval;
a switching means for electrically connecting a controller to said interface cable to transfer a data between said controller and said peripheral during said idle interval without consuming memory or CPU resources of the computer controlled system; and
a communications port for receiving commands from a second computer and transferring said data with said controller.

2. The system of claim 1, wherein said means for monitoring an interface cable further comprises:
a crimp for displacing an insulation of a wire of the interface cable and making electrical contact with said wire;
a second interface cable for electrically connecting said wire to said controller.

3. The system of claim 1, wherein said peripheral is a hard drive and said peripheral controller is a hard drive controller.

4. The system of claim 1, wherein said peripheral and said peripheral controller utilize an interface protocol selected from the group consisting of IDE, EIDE, SCSI, ATA, PATA, SATA, and FDDI.

5. The system of claim 1, wherein said communications port is selected from the group consisting of a network interface, a serial interface, a fiberoptic interface, a wireless network interface, an 802.11 interface, a WIFI interface, an RS-232 interface, a USB interface, a 1394 interface, an Ethernet interface, and a 10/100/1000 base T interface.

6. The system of claim 1, wherein said controller resides on a peripheral interface card that plugs into a I/O expansion slot of the computer controlled system.

7. The system of claim 1, wherein said data is transferred to said peripheral and alters a functional operation of the computer controlled system.

8. A system for controlling a legacy computer controlled system, comprising:
a first crimping portion of a coupler for electrically connecting to a peripheral data cable of the legacy computer controlled system by displacing an insulating layer surrounding a wire of said peripheral data cable and contacting said wire;
a second crimping portion of a coupler for securing said first crimping portion to said peripheral data cable; and
a second peripheral data cable in electrical communication with said wire, said second peripheral data cable transmitting a data to a peripheral hard drive of the legacy computer system via said wire during an interval when said legacy computer controlled system is not accessing said peripheral hard drive, said data altering a functional operation of the legacy computer controlled system.

9. The system of claim 8, further comprising:
a controller in electrical communication with said second peripheral data cable and said peripheral data cable, said controller transmitting said data to said second peripheral data cable.

10. The system of claim 8, further comprising:
a communications interface for communicating said data between an external computer system and the legacy computer controlled system via the controller.

11. The system of claim 10, wherein said communications interface is selected from the group consisting of a network interface, a serial interface, a fiberoptic interface, a wireless network interface, an 802.11 interface, a WIFI interface, an RS-232 interface, a USB interface, a 1394 interface, an Ethernet interface, and a 10/100/1000 base T interface.

12. The system of claim 10, wherein said controller resides on a peripheral interface card that plugs into a I/O expansion slot of the legacy computer controlled system.

13. The coupling of claim 8, wherein the legacy computer controlled system is a track system of a semiconductor wafer processing facility.

14. A method of controlling a computer comprising:
monitoring a data communications cable of the computer;
identifying an idle interval when the computer is not communicating with a hard drive using said data communications cable; and
switching a controller onto said data communications cable;
transmitting a data between said controller and said hard drive using said data communications cable, without consuming a memory resource or a cpu resource of the computer.

15. The method of claim 14, further comprising:
receiving said a command from a second computer system;
performing a data transfer between said controller and hard drive in response to said command; and
transferring a data between said controller and said second computer system in response to said command.

16. The method of claim 15 wherein said transferring is accomplished using an interface selected from the group consisting of network interface, a serial interface, a fiberoptic interface, a wireless network interface, an 802.11 interface, a WIFI interface, an RS-232 interface, a USB interface, a 1394 interface, an Ethernet interface, and a 10/100/1000 base T interface.

17. The method of claim 14, wherein said monitoring further comprises:
coupling electrically to said peripheral data communications cable using a coupler; and
coupling electrically said coupler to said controller;
monitoring the data and signal lines to identify an idle interval.
controller resides on a peripheral interface card that plugs into a I/O expansion slot of the legacy computer controlled system.

18. The method of claim 14, wherein said monitoring further comprises:
plugging said controller into an I/O expansion slot of the computer.

19. The method of claim 14, further comprising:
transmitting said data from said hard drive to the computer to affect an operation of the computer.

20. The method of claim 14, wherein said hard drive utilizes a protocol selected from the group consisting of IDE, EIDE, SCSI, ATA, PATA, SATA, and FDDI.

21. A device for interfacing with hard drives, comprising:
a target hard drive;
an interface cable; and
a target interface card.

22. A method of using the device in claim 21, comprising:
sitting outside the environment of the target hard drive; and
providing full, transparent data access.
